(19) United States
(12) Patent Application Publication
(10) Pub. No.: US 2018/0186657 A1
(43) Pub. Date: Jul. 5, 2018

(54) Treatment of Produced Water From A Subterranean Formation

(71) Applicant: Noles Intellectual Properties, LLC, Washington, OK (US)

(72) Inventor: Jerry W. Noles, Jr., Blanchard, OK (US)

(73) Assignee: Noles Intellectual Properties, LLC, Washington, OK (US)

(21) Appl. No.: 15/394,612

(22) Filed: Dec. 29, 2016

(51) Int. Cl. C02F 1/10; B01D 1/14; B01F 3/04; B01F 5/04

(52) U.S. Cl. CPC C02F 1/10; B01D 1/14; C02F 2101/10; B01F 5/0413; B01F 3/04248

(57) ABSTRACT

Systems for water treatment may include an evaporation unit, wherein the evaporation unit may comprise: a blower; a spacer, wherein the spacer may be fluidly coupled to the blower; wherein the evaporation unit may be configured to aerate and evaporate water.

### BACKGROUND

Within recent years, the oil and gas industry has developed the use of hydraulic fracturing to produce what was once considered nonproductive oil and gas formations. This hydraulic fracturing technology may require the use of high volumes of water to be pumped into subterranean wells under tremendous rates and pressures to pry rock apart, thereby allowing the oil and gas that is trapped within the matrix of the oil and gas formations to migrate to the wellbore and production casing. Although the use of this technology may have allowed high volumes of oil and gas recovery from the oil and gas formations, the use of these large volumes of water has been widely scrutinized. Because the water that may be used during these fracturing operations is preferably clean and free from contaminants, current technologies may use fresh water sources that may normally be used for irrigation and human consumption. The use of these fresh water supplies may have an impact on the availability of fresh water for human consumption and irrigation.

Although the water that may be pumped into the oil and gas formations may be recovered over the production life of the oil and gas well, the water may become contaminated with chemicals from the fracturing process and minerals that are leached from the producing reservoir during the production of the well. Many oil and gas reservoirs may have been created from decomposed organic matter generated from oceanic sea beds. Fresh water may mix with the salt water that may typically be produced from the hydrocarbon formations making both the frac water and the formation water unsuitable for human consumption or reuse for hydraulic fracturing. This water that may be produced or that flows back from the well may then be disposed of by pumping it into deep nonproductive oil and gas formations. This cycle may be repeated for each well and may use hundreds of thousands of barrels for each operation.

Recently this disposal process has come under scrutiny due to increased seismic activity that has occurred in conjunction with the pumping of the water into these subterranean reservoirs. It is for this reason that the industry has an increased need to find a way to reduce the amount of water that may be disposed of in these underground formations. The volume of water and the high level of the Total Dissolved Solids (“TDS”) may make it difficult to filter using a Reverse Osmosis unit for surface discharge purposes. In the past, distillation systems may have been used to evaporate and condense the water for discharge purposes. However, the cost for the energy or BTUs to distill the water proved to often be uneconomical to use on a large scale basis.

In another instance, evaporation processes may have been used to eliminate the water and recover the solids contained in the water. These systems may spray large volumes of water into the air using blowers and misting systems to evaporate the water. The solids may then fall into collection or evaporation pits. This process may be problematic due to wind causing the solids or salt to be blown outside of the evaporation pits or collection areas. This may then be compensated by the use of wind walls to prevent the drifting of the sprayed/misted water. These wind walls may generate static areas of high humidity air masses, thereby reducing the efficiencies of the evaporation process. In the past, this may have been compensated for by setting up wind sensors that would turn blowers on and off on different sides of the evaporation pits to compensate for wind direction.

In another instance, an enclosure may be placed over the entire evaporation pit to prevent drift caused by the wind. In this case, the enclosure may be ventilated to continuously move air into and out of the enclosure to avoid saturation of the air mass.

Therefore, there may exist a need for a system to evaporate and/or reduce the volumes of water that are being disposed of without the issues of containment that are generated by blowing high solids water into the atmosphere, and allowing them to fall into collection or evaporation pits.

### BRIEF DESCRIPTION OF THE DRAWINGS

These drawings illustrate certain aspects of some of the embodiments of the present disclosure and should not be used to limit or define the disclosure.

FIG. 1 illustrates a chart showing volumetric air requirements for evaporation based on the temperature of the air mass.

FIG. 2 illustrates an evaporation unit in accordance with embodiments of the present disclosure.

FIG. 3 illustrates a plurality of evaporation units in accordance with embodiments of the present disclosure.

FIG. 4 illustrates a top view of a diffuser in accordance with embodiments of the present disclosure.

FIG. 5 illustrates an arm with a plurality of apertures in accordance with embodiments of the present disclosure.

FIG. 6 illustrates an arm comprising a plurality of hollow tubes in accordance with embodiments of the present disclosure.

FIG. 7 illustrates an arm comprising a venturi in accordance with embodiments of the present disclosure.

FIG. 8 illustrates an arm comprising a screen in accordance with embodiments of the present disclosure.

FIG. 9 illustrates an alternate embodiment of an evaporation unit without a diffuser positioned in a water storage pit in accordance with the present disclosure.

FIG. 10 illustrates an alternate embodiment of a plurality of evaporation units without diffusers positioned in a water storage pit in accordance with the present disclosure.

FIG. 11 illustrates another embodiment of an evaporation unit without a diffuser positioned completely in a storage tank in accordance with the present disclosure.

FIG. 12 illustrates an alternate embodiment of a plurality of evaporation units without diffusers positioned completely in a storage tank in accordance with the present disclosure.

FIG. 13 illustrates another embodiment of an evaporation unit with a blower positioned on top of a storage tank in accordance with the present disclosure.

FIG. 14 illustrates an alternate embodiment of a plurality of evaporation units with blowers positioned on top of a storage tank in accordance with the present disclosure.

FIG. 15 illustrates another embodiment of an evaporation unit positioned completely inside a storage tank in accordance with the present disclosure.

FIG. 16 illustrates an alternate embodiment of a plurality of evaporation units positioned completely inside a storage tank in accordance with the present disclosure.

FIG. 17 illustrates another embodiment of an evaporation unit with a blower positioned on top of a storage tank in accordance with the present disclosure.

FIG. 18 illustrates an alternate embodiment of a plurality of evaporation units with blowers positioned on top of a storage tank in accordance with the present disclosure.

### DETAILED DESCRIPTION

Water may exist naturally in subterranean formations and may be produced in conjunction with hydrocarbons from the subterranean formations. Water may also be injected into a subterranean formation to stimulate hydrocarbon production (e.g., hydraulic fracturing or fracking). When the water is produced from the subterranean formations, it may comprise amounts of dissolved salts and other substances which may make it unsuitable for agriculture and human consumption.

The present disclosure may generally relate to the treatment of contaminated water (e.g. salt water/brine), and more specifically to the evaporation of water produced from a subterranean formation. Embodiments of the present disclosure may include mechanical agitation with submerged aeration to saturate an air mass, thereby accelerating the evaporation process, without generating the environmental concerns of high TDS fluids being carried outside of the evaporation zone. Brine may comprise a brine solution comprising at least 10 wt % NaCl. In some embodiments, brine may comprise a brine solution comprising about 10 wt % NaC1 to about 25 wt % NaCl. In other embodiments, brine may comprise a brine solution comprising more than 25 wt % NaCl. Other ranges may include ranges above what may be considered dischargeable to surface ground waters. As the water becomes concentrated and saturated with salts, the heavier water may be pulled off and then injected into subterranean disposal wells at significantly lower volumes then normal, thereby reducing the subsurface pressurization and aiding in prevention of seismic occurrences.

By allowing air to be mixed and released below the water surface, the air mass may become saturated before it breaks the surface of the water. Systems, methods and devices of the present disclosure may substantially improve the evaporation efficiency of the water by allowing the air mass temperature to rise to the temperature of the water contained in a pit that the air mass is in contact with, which may be above the temperature of the air mass above the pit. This may be important during winter months where the air mass temperatures within certain regions may be below 30° F. Systems, methods and devices of the present disclosure may also allow for high rates of oxygen transfer due to the high volumes of air (e.g., 100,000 cubic feet of air per minute) that may be moved. By increasing the air that may be in contact with the water, the amount of dissolved oxygen may be increased. Standard aeration systems may use as much as 1,500 horsepower to move 5,000 cubic feet of air per minute. Of this 5,000 cfm, only a small percentage of the air mass may go into solution in the form of dissolved oxygen. This may typically be around 2% of the oxygen that is within the air mass, which may render the system 98% inefficient. To overcome these inefficiencies, higher volumes of air may be moved at lower horsepower (“HP”). In comparison, a 50 HP axial fan may move 100,000 cubic feet per minute (“cfm”), thereby increasing the amount of dissolved oxygen per horsepower by more than 30 times. In the past, aeration systems have relied on moving air (e.g., an air mass) into water in order to infuse oxygen into the water or setting up blowers that would feed headers, and the headers would then feed control lines that went into the water at various depths to feed diffusers or other mechanisms to distribute the air into the water. Systems, methods and devices of the present disclosure may eliminate the need for headers or control lines to distribute the air into the water.

In certain embodiments, flow back and/or produced water may be pumped or hauled into a storage pit or storage reservoir via trucks or other gathering systems. Blowers may be placed into the pit and spaced based on volumetric requirements for evaporation or for aeration purposes.

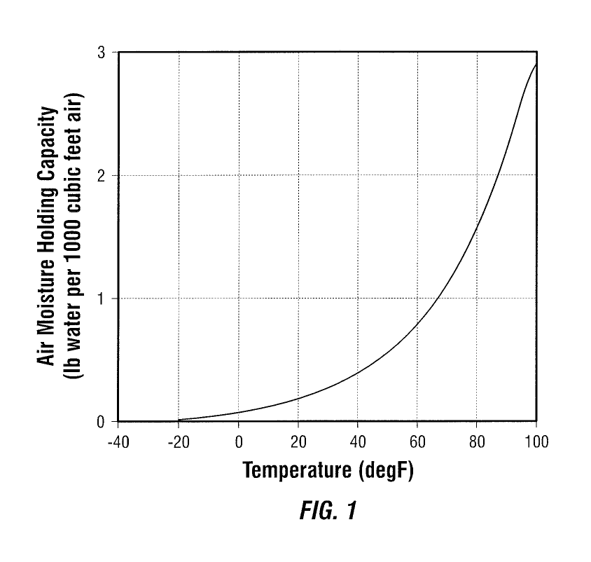

FIG. 1 illustrates a chart showing volumetric air requirements for evaporation based on the temperature of the air mass. It should be noted that the number of pounds of water that may be evaporated per 1,000 cubic feet of air may be highly dependent on the initial relative humidity of the air mass and the temperature of the air. This relative humidity may fluctuate during the course of the day. Therefore, systems, methods and devices of the present disclosure may include programs configured to turn on systems and devices of the present disclosure during low relative humidity times of about 30% to about 70%, thereby lowering the cost of energy and improving the efficiencies of a vapor transfer. For example, if the number of pounds of water per 1,000 cubic feet of air is 1, and the relative humidity is 70%, then the pounds of water that the 1,000 cubic feet may be capable of absorbing before becoming saturated or reaching 100% relative humidity may be 0.30 or 30% of the 1 pound per thousand cubic feet. Therefore, a blower that may move 10,000 cubic feet per minute may be capable of evaporating about 3 pounds of water per minute at an initial air mass relative humidity of 70%. However, at an initial relative humidity of 30%, about 7 pounds of water per minute may be evaporated. Based on this calculation, the average annual relative humidity may be used to calculate the number of evaporation devices and the size of the evaporation devices to achieve a certain volume of evaporation per day. The moisture holding capacity of air may be 1 lb of water per 1,000 cubic feet of dry air. The moisture holding capacity of air at 100° F. may be about 10 times the moisture holding capacity of air at 30° F. This may be an important observation, especially when working in areas where air temperatures may be low during certain times of the year.

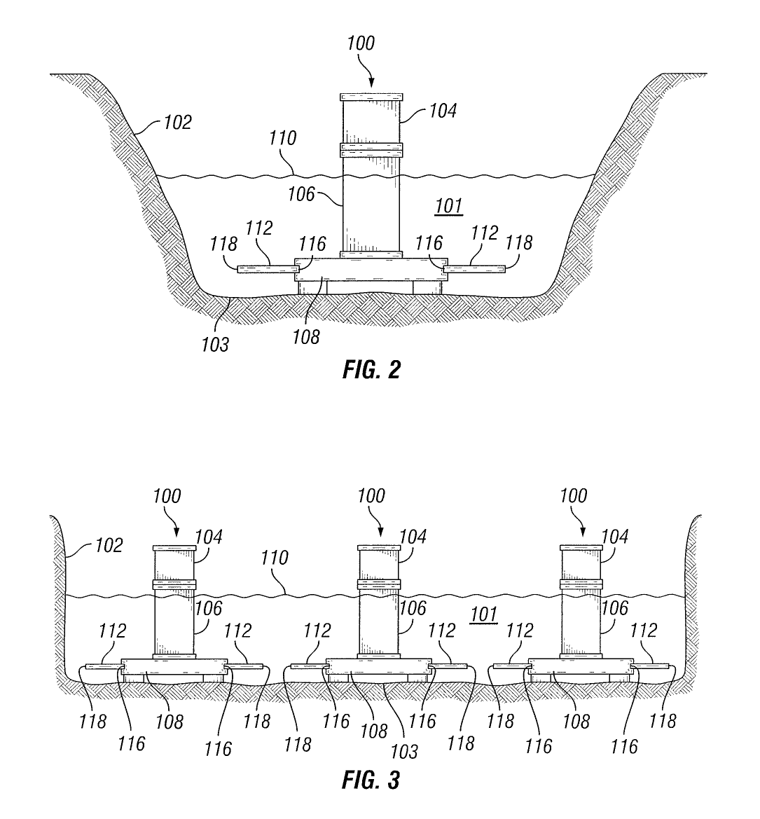

FIG. 2 illustrates an evaporation unit 100. Evaporation unit 100 may include blower 104, spacer 106, and diffuser 108. Evaporation unit 100 may be positioned within a body of water 101 of storage pit 102 for water (e.g., produced water which may include brine). The spacer 106 and diffuser 108 may be submerged (completely or partially) in the body of water 101. Blower 104 may be above the water surface 110. The body of water 101 may be received and stored in storage pit 102 from a subterranean formation. In embodiments, evaporation unit 100 may be electrically powered and may be placed at a depth below the water surface 110. This may range from about 4 inches below the water surface 110 to about 30 feet, relative to water surface 110. Evaporation unit 100 may also be powered by any other suitable source. Evaporation unit 100 may have a weight from about 200 lbs to about 1,000 lbs. Evaporation unit 100 may be suitable for gas-liquid reactions at temperatures below about 160° F. and pressures below about 30 psi. Evaporation unit 100 may biologically degrade organic substances and may further oxidize organic substances. Evaporation unit 100 may also provide aeration with any suitable gas, such as, for example, air, pure oxygen, ozone, CO₂, and the like. Placement/removal of evaporation unit 100 into/from storage pit 102 may be accomplished with a crane or any other suitable device. For example, a crane may lift/remove evaporation unit 100 from storage pit 102 (e.g., for maintenance, completion of evaporation process) and may place evaporation unit 100 into storage pit 102.

Blower 104 may include a high volume blower that may be placed above the water surface 110. Blower 104 may move over 100,000 cubic feet of air per minute. In certain embodiments, blower 104 may move about 10,000 cubic feet of air per minute to about 500,000 cubic feet of air per minute. In some embodiments, multiple blowers 104 may be incorporated to move higher volumes. Blower 104 may be fluidly coupled to spacer 106. The inner diameter of blower 104 may be about 12 inches to about 96 inches. Blower 104 may be electrically powered and may include a motor rated from about 7 horsepower to about 150 horsepower. Blower 104 may also be powered by any other suitable means. Blower 104 may include ducted fans. Historically, ducted fans have not been used for aeration applications due to their inability to overcome high head pressure without cavitation. In order to compensate for the low pressure, high volume capability of the ducted fans and function at greater depths, a small amount or about 5% to about 10% of the overall volume of the fan may be released along the spacer 106 and at sufficiently shallow depths, between about 4 inches to about 12 inches, into the body of water 101 as to allow the hydrostatic head pressure of the water to be gas cut thereby reducing the head pressure and allowing the air to then migrate to the next depth. Once the hydrostatic head pressure has been sufficiently gas cut to allow blower 104 to push air to the lowest point of the evaporation unit 100, the weight of water 101 in proximity of the outside of the evaporation unit 100 may be reduced by the volumetric displacement value of the air occupying that space. An example of this may be if the weight of the water 101 is 9.6 pounds per gallon in the storage pit 102, and the head pressure at a depth of 14 feet is 6.8 psi. By adding 50% by volume of air, the head pressure may be reduced to 3.4 psi or below the pressure values of the blower 104 capabilities.

Spacer 106 may include a hollow cylindrical pipe that may have an inner diameter that may reduce any friction from a moving air mass within spacer 106. Spacer 106 may extend from several feet above the water surface 110 to below the water surface 110. Spacer 106 may be made of any suitable material, such as, for example, metal (e.g., steel, alloys). The inner diameter of spacer 106 may be about 12 inches to about 96 inches. Spacer 106 may be designed to direct an air mass throughout the storage pit 102 to increase the amount of water (e.g., body of water 101) that the air mass is in contact with, thereby improving the evaporation or saturation of the air mass. Spacer 106 may be fluidly coupled to diffuser 108. Diffuser 108 may be positioned at a depth that may be below the water surface 110 and above a maximum head pressure that the blower 104 may be capable of generating. Diffuser 108 may be placed on the bottom 103 of storage pit 102. The coupling of the blower 104 to spacer 106 and the coupling of spacer 106 to diffuser 108 may be accomplished by any suitable means, such as, for example, threads, welds, bolts or combinations thereof. This coupling may eliminate the need for manifolds or headers to transfer the air from remotely positioned blowers. This coupling may further reduce the need for after coolers to be used to cool the air mass, thereby preventing damage to the diffuser 108. This coupling may also reduce friction, thereby reducing overall horsepower requirements.

During operation of evaporation unit 100, blower 104 may capture (e.g., via suction) an air mass from the surrounding area and may blow/force the air mass through spacer 106 into diffuser 108. The air mass may then exit diffuser 108 into the body of water 101, thereby aerating the body of water 101. The diffuser 108 may break the air mass into smaller bubbles (e.g., microbubbles) to increase the evaporation uptake of the air mass. Microbubbles may be bubbles with a diameter greater than 1 micrometer and less than 1 millimeter. Diffuser 108 may also provide turbulence and movement of the water (e.g., body of water 101), thereby increasing surface evaporation and fluid mixing. The turbulence of the air mass as it passes through the body of water 101 may provide sufficient contact time as to allow the air mass to become fully or partially saturated. This may be important when the evaporation unit 100 is used for aeration of waste water treatment to aid in aerobic bacterial digestion or water clarification. As the water evaporates, substances (e.g., salt) in the body of water 101 (e.g., salt) may accumulate at the bottom of storage pit 102. The fallen substances (e.g., salt) may be removed from storage pit 102 to a storage container and/or vehicle. The unitized structure (e.g., the coupling of blower 104 to spacer 106 and the coupling of spacer 106 to diffuser 108) of evaporation unit 100 may substantially reduce the cost and infrastructure in treating contaminated water. Evaporation unit 100 may be deployed within minutes or hours, thereby allowing them to be moved from site to site based on demand. It should be noted that although a single evaporation unit 100 is depicted in FIG. 2, a plurality of evaporation units 100 may be utilized, as shown in FIG. 3.

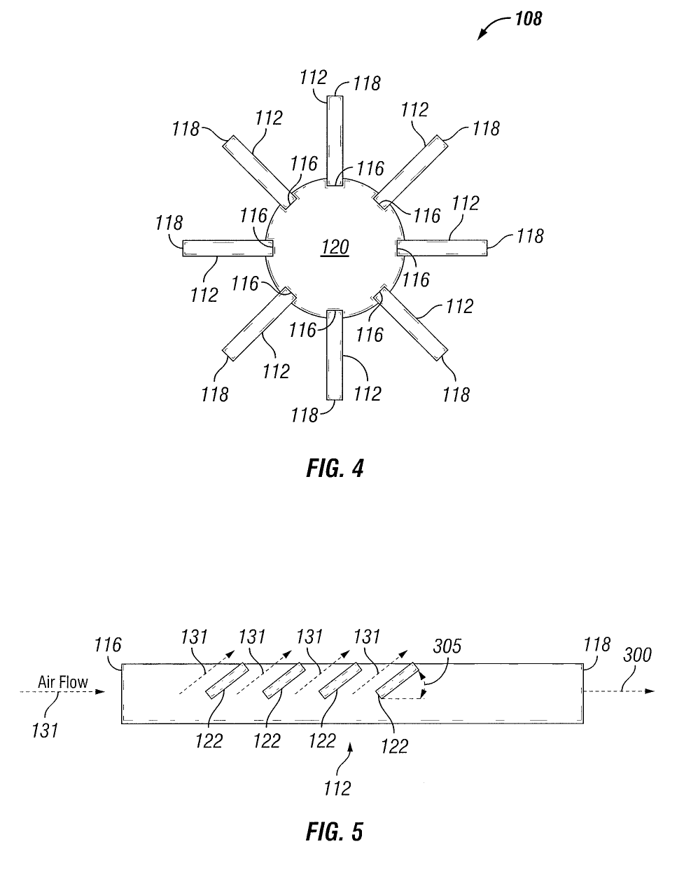

FIG. 4 illustrates a top view of diffuser 108. Diffuser 108 may comprise a plurality of arms 112 and a circular portion 120. The configuration of diffuser 108 may resemble a hub and spokes configuration. Each arm 112 may comprise a proximal end 116 and a distal end 118. Proximal end 116 may be coupled to circular portion 120 by any suitable means such as welds. Each arm 112 may be hollow and tubular in shape. In some embodiments, the plurality of arms 112 may rotate, allowing water within the arms 112 to be centrifugally evacuated, thereby generating a cavitation effect and aiding to overcome head pressure of the water, which may allow the air to exit deeper below the water surface 110. Arms 112 may be of a rectangular tubing and may be of a length between about 12 inches to about 96 inches. These arms 112 may be configured to allow the rotation to create a negative pressure behind a leading edge of the arm 112 as to allow air to be drafted out into the body of water 101 from the blower 104. Each arm 112 may have a configuration as described below in FIGS. 5-8.

FIG. 5 illustrates an arm 112 with a plurality of apertures 122 (e.g., slots). Each aperture 122 may have a diameter from about 1 inch to about 2 inches, and may be configured to funnel an air mass as the air mass exits each aperture 122, thereby creating microbubbles in a body of water (e.g., body of water 101 shown on FIG. 2). During operation of evaporation unit 100, blower 104 may capture (e.g., via suction) an air mass from the surrounding area and may blow/force the air mass through spacer 106 into diffuser 108. The flow of the air mass is denoted by arrows 131. The air mass may then exit diffuser 108 via apertures 122 into the body of water 101, thereby aerating the body of water 101. Apertures 122 may provide an air flow at angle 305 relative to the central axis (denoted by reference number 300). Angle 305 may be any suitable angle to create the microbubbles. In embodiments, angle 305 may be about 10° to about 90°, alternatively about 10° to about 75°, and alternatively about 40° to about 50° (e.g.,) 45°.

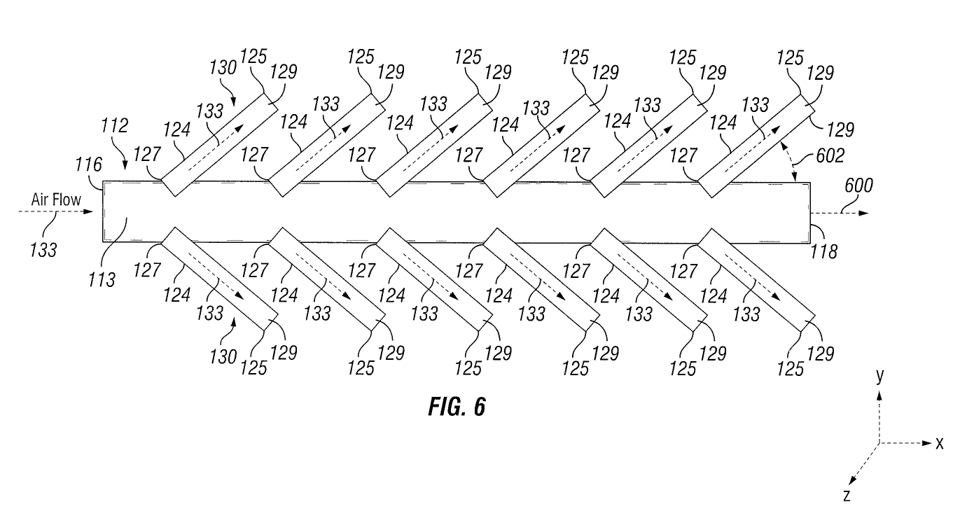

FIG. 6 illustrates an arm 112 comprising a plurality of hollow tubes 124. As shown, tubes 124 extend outward from arm 112. The plurality of hollow tubes 124 may each comprise a proximal end 127, which may be fluidly coupled to the body 113 of arm 112 by any suitable means such as welds. Each hollow tube 124 may be coupled to body 113 at angle 602 relative to the central axis 600 of arm 112. Angle 602 may be any suitable angle to create the microbubbles. In embodiments, angle 602 may be about 10° to about 90°, alternatively about 10° to about 75°, and alternatively about 40° to about 50° (e.g.,) 45°. Each tube 124 may have a length of about 8 inches to about 12 inches with an inner diameter of about 1 inch to about 4 inches. Each tube 124 may have an opening 125 positioned at a distal end 129 of each tube 124. Each tube 124 may be configured to create microbubbles in a body of water (e.g., body of water 101 shown on FIG. 2) as an air mass exits each tube 124 via opening 125. During operation of evaporation system 100, blower 104 (e.g., as shown on FIG. 2) may capture (e.g., via suction) an air mass from the surrounding area and may blow/force the air mass through spacer 106 into diffuser 108. The flow of the air mass is denoted by arrows 133. The air mass may then exit diffuser 108 via hollow tubes 124 into the body of water 101, thereby aerating the body of water 101.

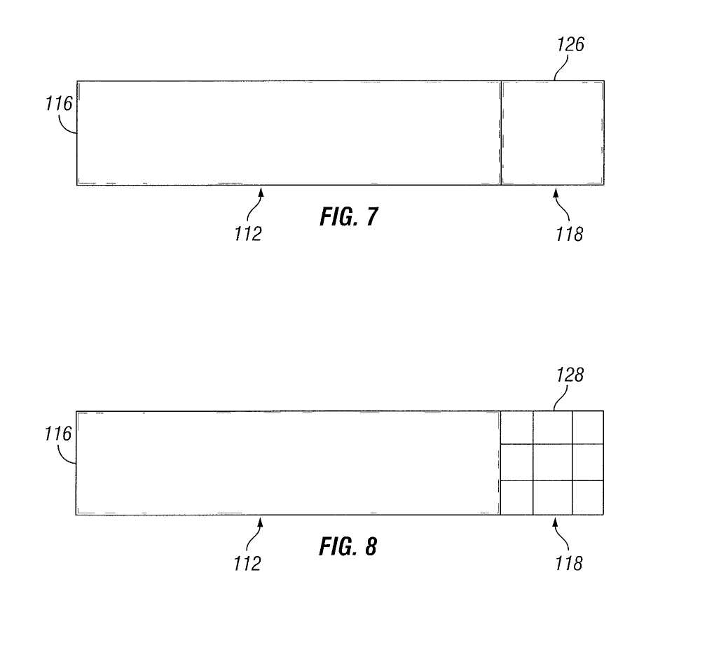

FIG. 7 illustrates an arm 112 with a venturi 126 fluidly coupled to distal end 118. Venturi 126 may be coupled to arm 112 by any suitable means such as welds. Venturi 126 may be configured to create microbubbles in a body of water (e.g., body of water 101 shown on FIG. 2) as an air mass exits the venturi 126. It is to be understood that venture 126 refers to a constricted section of pipe that causes a reduction in fluid pressure. During operation of evaporation system 100, blower 104 (e.g., as shown on FIG. 2) may capture (e.g., via suction) an air mass from the surrounding area and may blow/force the air mass through spacer 106 into diffuser 108. The air mass may then exit diffuser 108 via venturi 126 into the body of water 101, thereby aerating the body of water 101.

FIG. 8 illustrates an arm 112 with a screen 128 coupled to distal end 118 by any suitable means, such as, welds. Screen 128 may be made from any suitable metal, such as, for example, stainless steel. Screen 128 may be configured to create microbubbles in a body of water (e.g., body of water 101 shown on FIG. 2) as air passes/exits through screen 128. Mesh size of the screen 128 may be about 20 to about 100 mesh. During operation of evaporation system 100, blower 104 (e.g., as shown on FIG. 2) may capture (e.g., via suction) an air mass from the surrounding area and may blow/force the air mass through spacer 106 into diffuser 108. The air mass may then exit diffuser 108 via screen 128 into the body of water 101, thereby aerating the body of water 101.

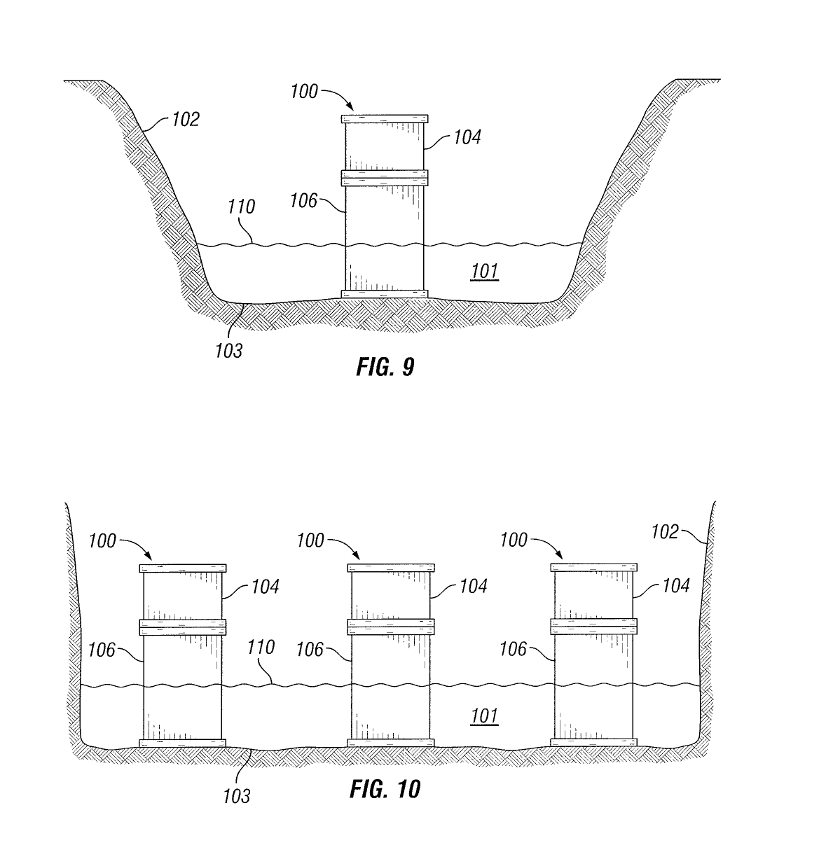

FIG. 9 illustrates another embodiment of evaporation unit 100. Evaporation unit 100 may be positioned within a body of water 101 of storage pit 102 (e.g., storage pit may contain produced water which may include brine). Evaporation unit 100 may include blower 104 and a spacer 106, as described above. The spacer 106 may be submerged (completely or partially) in the body of water 101. Blower 104 may be above the water surface 110. The body of water 101 may be received and stored in storage pit 102 from a subterranean formation.

During operation of evaporation unit 100, blower 104 may capture (e.g., via suction) an air mass from the surrounding area and may blow/force the air mass through spacer 106 into the body of water 101, thereby aerating the body of water 101, as described above. The turbulence of the air mass as it passes through the body of water 101 may provide sufficient contact time as to allow the air mass to become fully or partially saturated. As the water evaporates, substances (e.g., salt) in the body of water 101 (e.g., salt) may accumulate at the bottom 103 of storage pit 102. It should be noted that although a single evaporation unit 100 is depicted in FIG. 9, a plurality of evaporation units 100 may be utilized, as shown in FIG. 10.

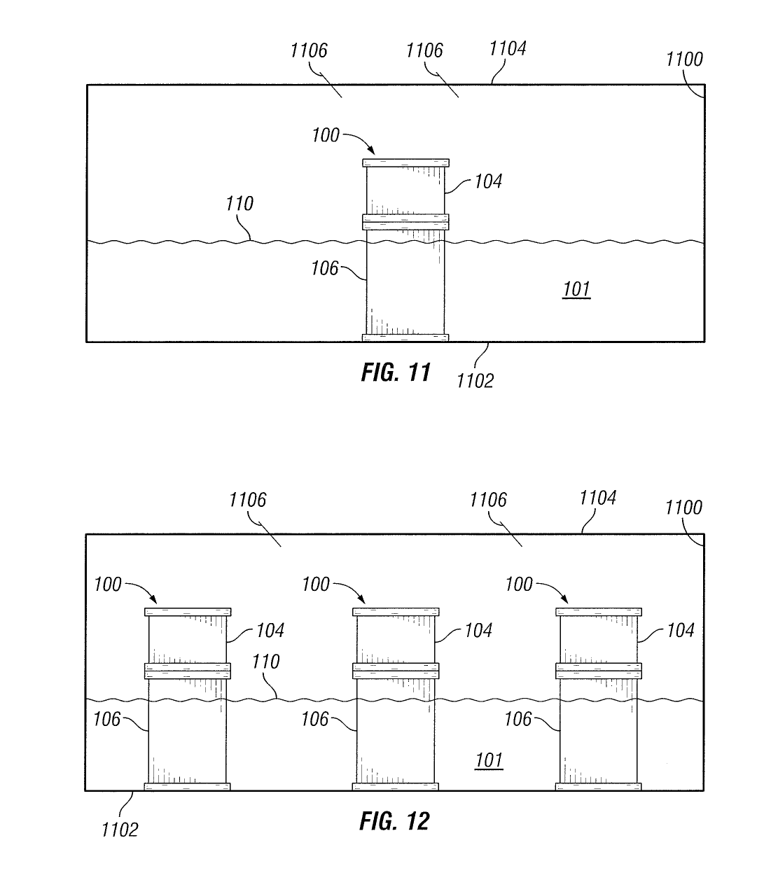

FIG. 11 illustrates another embodiment of evaporation unit 100. Evaporation unit 100 may include blower 104 and a spacer 106, as described above. Evaporation unit 100 may be positioned completely inside storage tank 1100 (e.g., above ground storage tank or below ground storage tank). Storage tank 1100 may include vents 1106. Spacer 106 may be positioned within a body of water 101 of storage tank 1100 (e.g., storage tank may contain produced water which may include brine). Blower 104 may be positioned above water surface 110. The body of water 101 may be received and stored in storage tank 1100 from a subterranean formation.

During operation of evaporation unit 100, blower 104 may capture (e.g., via suction) an air mass from the surrounding area and may blow/force the air mass through spacer 106 into the body of water 101, thereby aerating the body of water 101, as described above. The turbulence of the air mass as it passes through the body of water 101 may provide sufficient contact time as to allow the air mass to become fully or partially saturated. As vapor escapes from the top (e.g., roof 1104) of tank 1100 (e.g., via vents 1106), any solids in the body of water 101 may accumulate at the storage tank floor 1102. It should be noted that although a single evaporation unit 100 is depicted in FIG. 11, a plurality of evaporation units 100 may be utilized, as shown in FIG. 12.

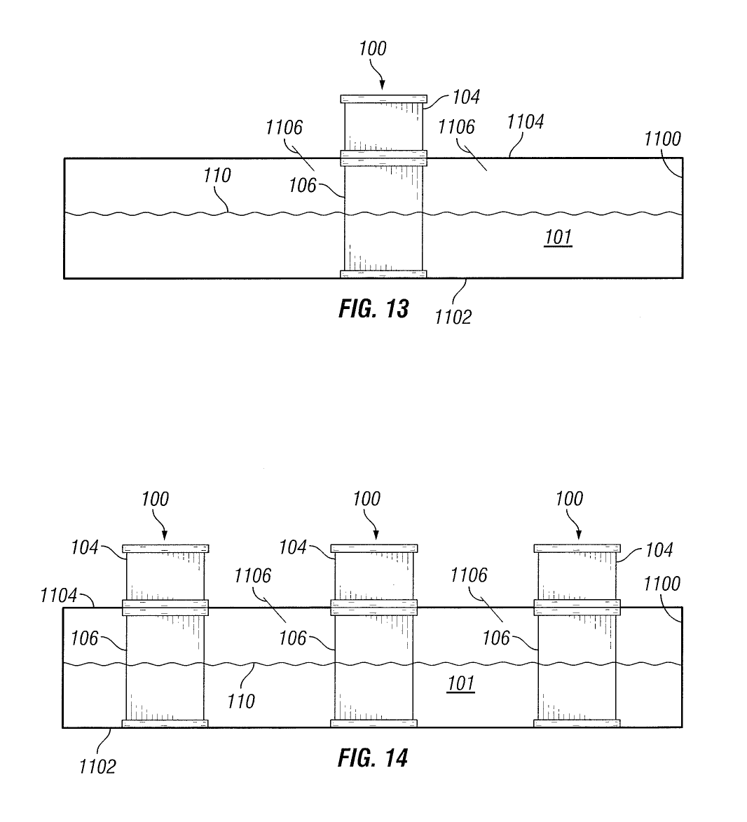

FIG. 13 illustrates another embodiment of evaporation unit 100. Evaporation unit 100 may include blower 104 and a spacer 106, as described above. A portion (e.g., spacer 106) of evaporation unit 100 may be positioned within storage tank 1100 (e.g., above ground storage tank or below ground storage tank that may contain produced water which may include brine). Storage tank 1100 may include vents 1106. Blower 104 may be placed on top (e.g., roof 1104) of storage tank 1100. Spacer 106 may extend from blower 104 into the body of water 101. Blower 104 may be secured to roof 1104 by any suitable means, such as, welds, bolts, screws, or combinations thereof. The body of water 101 may be received and stored in storage tank 1100 from a subterranean formation.

During operation of evaporation unit 100, blower 104 may capture (e.g., via suction) an air mass from the surrounding area and may blow/force the air mass through spacer 106 into the body of water 101, thereby aerating the body of water 101, as described above. The turbulence of the air mass as it passes through the body of water 101 may provide sufficient contact time as to allow the air mass to become fully or partially saturated. As vapor escapes from the top (e.g., roof 1104) of tank 1100 (e.g., via vents 1106), any solids in the body of water 101 may accumulate at the storage tank floor 1102. It should be noted that although a single evaporation unit 100 is depicted in FIG. 13, a plurality of evaporation units 100 may be utilized, as shown in FIG. 14.

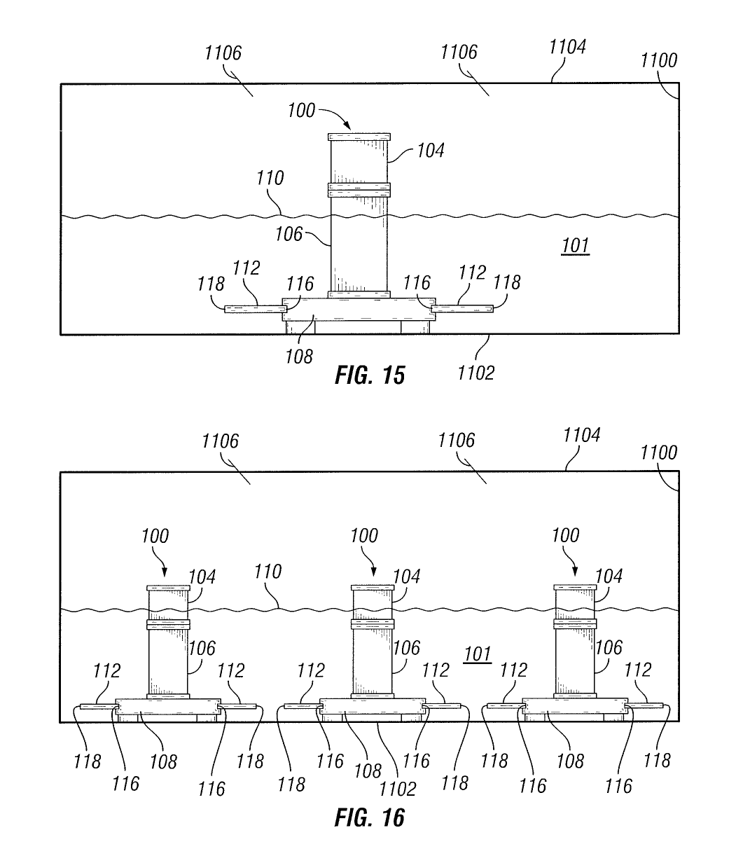

FIG. 15 illustrates another embodiment of evaporation unit 100. Evaporation unit 100 may include blower 104, spacer 106, and diffuser 108. Evaporation unit 100 may be positioned completely inside storage tank 1100 (e.g., above ground storage tank or below ground storage tank that may contain produced water which may include brine). Storage tank 1100 may include vents 1106. Spacer 106 and diffuser 108 may be submerged (completely or partially) within the body of water 101 of storage tank 1100. Blower 104 may be positioned above water surface 110 and within storage tank 1100. The water 101 may be received and stored in storage tank 1100 from a subterranean formation.

During operation of evaporation unit 100, blower 104 may capture (e.g., via suction) an air mass from the surrounding area and may blow/force the air mass through spacer 106 and diffuser 108 into the body of water 101, thereby aerating the body of water 101, as described above. The turbulence of the air mass as it passes through the body of water 101 may provide sufficient contact time as to allow the air mass to become fully or partially saturated. As vapor escapes from the top (e.g., roof 1104) of tank 1100 (e.g., via vents 1106), any solids in the body of water 101 may accumulate at the storage tank floor 1102. It should be noted that although a single evaporation unit 100 is depicted in FIG. 15, a plurality of evaporation units 100 may be utilized, as shown in FIG. 16.

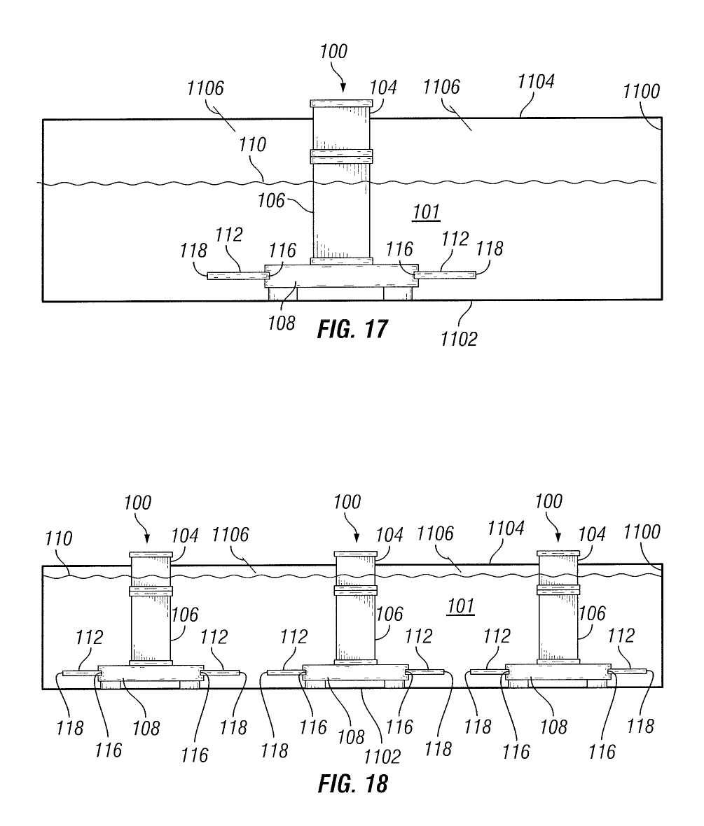

FIG. 17 illustrates another embodiment of evaporation unit 100. Evaporation unit 100 may include blower 104, spacer 106, and diffuser 108, as described above. A portion (e.g., spacer 106 and diffuser 108) of evaporation unit 100 may be positioned in storage tank 1100 (e.g., above ground storage tank or below ground storage tank that may contain produced water which may include brine). Blower 104 may be placed on top (e.g., roof 1104) of storage tank 1100. Spacer 106 and diffuser 108 may be submerged (completely or partially) within the body of water 101 of storage tank 1100. Blower 104 may be secured to roof 1104 by any suitable means, such as, welds, bolts, screws, or combinations thereof. The body of water 101 may be received and stored in storage tank 1100 from a subterranean formation.

During operation of evaporation unit 100, blower 104 may capture (e.g., via suction) an air mass from the surrounding area and may blow/force the air mass through spacer 106 into the body of water 101, thereby aerating the body of water 101, as described above. The turbulence of the air mass as it passes through the body of water 101 may provide sufficient contact time as to allow the air mass to become fully or partially saturated. As vapor escapes from the top (e.g., roof 1104) of tank 1100 (e.g., via vents 1106), any solids in the body of water 101 may accumulate at the storage tank floor 1102. It should be noted that although a single evaporation unit 100 is depicted in FIG. 17, a plurality of evaporation units 100 may be utilized, as shown in FIG. 18.

It is believed that the operation and construction of the present disclosure will be apparent from the foregoing description. While the apparatus and methods shown or described above have been characterized as being preferred, various changes and modifications may be made therein without departing from the spirit and scope of the disclosure as defined in the following claims.

What is claimed is:

1. An evaporation unit comprising:
a blower; and
a spacer, wherein the spacer is fluidly coupled to the blower;
wherein the evaporation unit is configured to aerate and evaporate water.

2. The evaporation unit of claim 1, further comprising a diffuser, wherein the diffuser is fluidly coupled to the spacer, wherein the diffuser comprises a plurality of arms.

3. The evaporation unit of claim 1, wherein the evaporation unit is positioned in a storage tank, wherein the storage tank comprises a body of water.

4. The evaporation unit of claim 1, wherein the evaporation unit is positioned in a storage pit, wherein the storage pit comprises a body of water.

5. The evaporation unit of claim 4, wherein the spacer is submerged in the body of water.

6. The evaporation unit of claim 1, wherein the blower is positioned on top of a storage tank, wherein the storage tank comprises a body of water.

7. The evaporation unit of claim 6, wherein the spacer is submerged in the body of water.

8. A system comprising:
a plurality of evaporation units, wherein each evaporation unit comprises:
a blower; and
a spacer, wherein the spacer is fluidly coupled to the blower;
wherein each evaporation unit is configured to aerate and evaporate water.

9. The system of claim 8, wherein each evaporation unit further comprises a diffuser, wherein the diffuser is fluidly coupled to the spacer, wherein the diffuser comprises a plurality of arms.

10. The system of claim 8, wherein each evaporation unit is positioned in a storage pit, wherein the storage pit comprises a body of water.

11. The system of claim 8, wherein each evaporation unit is positioned in a storage tank, wherein the storage tank comprises a body of water.

12. The system of claim 11, wherein the spacer is submerged in the body of water.

13. The system of claim 8, wherein the blower is positioned on top of a storage tank, wherein the storage tank comprises a body of water.

14. The system of claim 13, wherein the spacer is submerged in the body of water.

15. A method comprising:
positioning an evaporation unit in a body of water, wherein the evaporation unit comprises:
a blower; and
a spacer, wherein the spacer is fluidly coupled to the blower;
wherein the evaporation unit is configured to aerate and evaporate water;
capturing air with the blower;
forcing the air through the spacer, the diffuser and into the body of water; and
aerating and evaporating the water with the evaporation unit.

16. The method of claim 15, wherein the evaporation unit further comprises a diffuser, wherein the diffuser is fluidly coupled to the spacer, wherein the diffuser comprises a plurality of arms.

17. The method of claim 16, wherein the plurality of arms comprise a screen.

18. The method of claim 15, wherein the body of water is located in a storage pit.

19. The method of claim 15, wherein the body of water is located in a storage tank.

20. The method of claim 15, wherein an inner diameter of the blower is from about 12 inches to about 96 inches.
